(19) United States
(12) Patent Application Publication
(10) Pub. No.: US 2026/0352129 A1
(43) Pub. Date: Nov. 5, 2026

(54) INDUCTANCE MEASURING DEVICE AND INDUCTANCE MEASURING METHOD

(71) Applicant: MITSUBISHI ELECTRIC CORPORATION, Tokyo (JP)

(72) Inventor: Takashi HOZUKI, Tokyo (JP)

(73) Assignee: MITSUBISHI ELECTRIC CORPORATION, Tokyo (JP)

(21) Appl. No.: 19/481,884

(22) PCT Filed: Aug. 4, 2023
(86) PCT No.: PCT/JP2023/028533

§ 371 Date: Nov. 6, 2025

(51) Int. Cl. H02P 23/14; H02P 25/022

(52) U.S. Cl. CPC H02P 23/14; H02P 25/022

(57) ABSTRACT

An inductance measuring device for measuring inductances of a multigroup multiphase AC machine defines one of a plurality of winding groups of the multigroup multiphase AC machine as a self-measurement group and defines a winding group other than the self-measurement group as an interference measurement group, and includes: voltage application means which applies, to the self-measurement group, measurement voltage which does not drive the multigroup multiphase AC machine; voltage application means which applies, to the interference measurement group, interference measurement voltage which is voltage for controlling current of the interference measurement group to be 0, and which does not drive the multigroup multiphase AC machine; and inductance calculation means which calculates a self-inductance of the self-measurement group and a mutual inductance from the self-measurement group to the interference measurement group, on the basis of current of the self-measurement group and the interference measurement voltage command value.

### TECHNICAL FIELD

The present disclosure relates to an inductance measuring device and an inductance measuring method.

### BACKGROUND ART

A multigroup multiphase AC machine having a plurality of winding groups independent of each other in one electric motor has advantages that, for example, having multiple groups of the same windings enables increase in capacity and increase in torque, and enables control for each winding group, whereby harmonics of the electric motor can be reduced. For example, in a case of providing multiple groups of windings in orthogonal directions, each winding group serves as a stator of a multi-axis actuator, thus making it possible to configure an actuator with multiple degrees of freedom in which multiple shafts are integrated and directly driven. Owing to the above advantages, the multigroup multiphase AC machine is expected to contribute to output increase and size reduction of industrial equipment.

In such a multigroup multiphase AC machine, it is known that magnetic coupling occurs between the winding groups and influences each other's winding group. Specifically, control performance is deteriorated because of interference between the groups due to magnetic coupling, thus reducing control response and causing current ripple. With respect to such problems, a mutual inductance regarding an interfering magnetic flux is obtained through measurement in advance, and using the mutual inductance, magnetic interference between the winding groups is eliminated inside a controller for controlling the multigroup multiphase AC machine, whereby the above problems can be solved.

While the mutual inductance is obtained through analysis in advance, the value thereof does not always match the actual value due to manufacturing error of the actual AC machine and the like. In particular, in an electric motor having windings in multiple groups in orthogonal directions so as to be configured as an actuator with multiple degrees of freedom, if coils have manufacturing error which leads to phase shift, for example, a leakage magnetic flux occurring from one winding group unilaterally interferes with another winding group, so that an interfering magnetic flux is not uniformly generated. As a result, a mutual inductance Mzθ from one winding group z to another winding group θ and a mutual inductance Mez opposite thereto do not always coincide with each other. Therefore, it is desirable that an interference inductance when voltage is applied to each winding group can be measured.

The applicant has disclosed a method of measuring a self-inductance in a state in which rotation and vibration of a synchronous motor are suppressed by applying high-frequency rotation voltage having a fundamental frequency sufficiently higher than a synchronous rotation possible frequency of the synchronous motor (see, for example, Patent Document 1).

As another example, there is a method in which a stator magnetic flux in a d-q coordinate system is estimated from a corresponding value of stator current, a corresponding value of stator voltage, and an electrical angular velocity of a dual three-phase synchronous motor being driven and an inductance is identified through calculation from the stator magnetic flux and the stator current (see, for example, Patent Document 2).

### CITATION LIST

### Patent Document

Patent Document 1: Japanese Patent No. 5523584
Patent Document 2: Japanese Laid-Open Patent Publication No. 2020-184868

### SUMMARY OF THE INVENTION

### Problem to be Solved by the Invention

The technology disclosed in Patent Document 1 enables measurement of the self-inductance without rotating the synchronous motor, but application to a multigroup multiphase AC machine is not disclosed. Therefore, since a voltage command value set in the own way is used as a voltage value to be used for inductance calculation, the technology is not applicable to a case of measuring a mutual inductance of winding groups to which voltages are not applied in the multigroup multiphase AC machine.

On the other hand, in the technology disclosed in Patent Document 2, during drive control, a voltage command value is used to enable measurement for a mutual inductance of a dual winding PMSM (permanent magnet synchronous motor) which is a multigroup multiphase AC machine, without providing a voltage detector, but this is based on the premise that the AC machine is made into a rotationally driven state because an electrical angular velocity of a rotor is used.

Under the premise that the inductance is measured in the rotationally driven state of the AC machine, the timing of measurement is constrained. Therefore, a technology for measuring the mutual inductance of the multigroup multiphase AC machine in a state of not rotating the AC machine is required.

The present disclosure has been made to solve the above problem, and an object of the present disclosure is to provide an inductance measuring device that can measure the mutual inductance of a multigroup multiphase AC machine in a state of not rotating the AC machine.

### Means to Solve the Problem

An inductance measuring device according to the present disclosure is an inductance measuring device which measures inductances of a multigroup multiphase AC machine having a plurality of multiphase winding groups, the inductance measuring device including: voltage application means which applies voltage and current detection means which detects current, the voltage application means and the current detection means being provided for each of the plurality of winding groups; and inductance calculation means which calculates the inductances. One of the plurality of winding groups is defined as a self-measurement group, and the winding group other than the self-measurement group is defined as an interference measurement group. The voltage application means for the self-measurement group applies, to the self-measurement group, measurement voltage which is voltage based on a measurement voltage command value and which does not drive the multigroup multiphase AC machine. The voltage application means for the interference measurement group includes a current controller, and applies, to the interference measurement group, interference measurement voltage which is voltage based on an interference measurement voltage command value for controlling current of the interference measurement group to be 0, and which does not drive the multigroup multiphase AC machine. The inductance calculation means calculates a self-inductance of the self-measurement group and a mutual inductance from the self-measurement group to the interference measurement group, on the basis of the current detected by the current detection means for the self-measurement group and the interference measurement voltage command value.

### Effect of the Invention

According to the present disclosure, it becomes possible to measure the mutual inductance of a multigroup multiphase AC machine in a state of not rotating the AC machine.

### BRIEF DESCRIPTION OF THE DRAWINGS

FIG. 1 is a block diagram showing a configuration of an inductance measuring device for a multigroup multiphase AC machine according to embodiment 1.

FIG. 2 is a block diagram showing a configuration of an inductance measuring device for a two-group three-phase synchronous motor according to embodiment 1.

FIG. 3 is a block diagram showing a configuration of voltage command generation means in an interference measurement group according to embodiment 1.

FIG. 4 is a block diagram showing a configuration of inductance calculation means according to embodiment 1.

FIG. 5 is a flowchart illustrating an operation procedure of the inductance measuring device of the two-group three-phase synchronous motor according to embodiment 1.

FIG. 6 schematically shows a configuration example of the two-group three-phase synchronous motor which is a measurement target of the inductance measuring device according to each of embodiments 1 and 2.

FIG. 7A schematically shows a configuration example of a linear and rotary actuator which is a measurement target of the inductance measuring device according to each of embodiments 1 and 2.

FIG. 7B is an enlarged view of a stator winding group of the linear and rotary actuator shown in FIG. 7A, as seen from a lateral side.

FIG. 8 shows an example of a hardware configuration of the inductance measuring device according to each of embodiments 1 to 3.

### DESCRIPTION OF EMBODIMENTS

Hereinafter, embodiments will be described with reference to the drawings. In the drawings, the same reference characters denote the same or corresponding parts.

### Embodiment 1

Hereinafter, an inductance measuring device for a multigroup multiphase AC machine according to embodiment 1 will be described with reference to the drawings.

### <Configuration of Inductance Measuring Device 1>

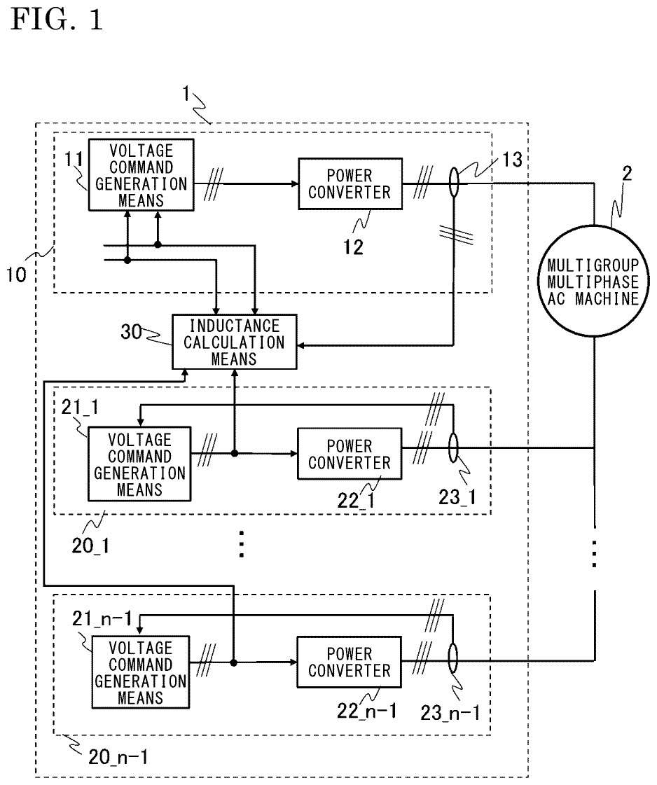

FIG. 1 is a block diagram showing a configuration of the inductance measuring device for the multigroup multiphase AC machine according to embodiment 1. An inductance measuring device 1 measures the inductance of a multigroup multiphase AC machine 2. The inductance measuring device 1 includes self-measurement group voltage application means 10 which applies voltage to a self-measurement group, interference measurement group voltage application means 20 which applies voltage to an interference measurement group, and inductance calculation means 30. Where the number of groups of windings is denoted by n (n is a natural number not less than 2), there are (n−1) interference measurement groups, and interference measurement group voltage application means 20_1 to 20_n−1 are provided.

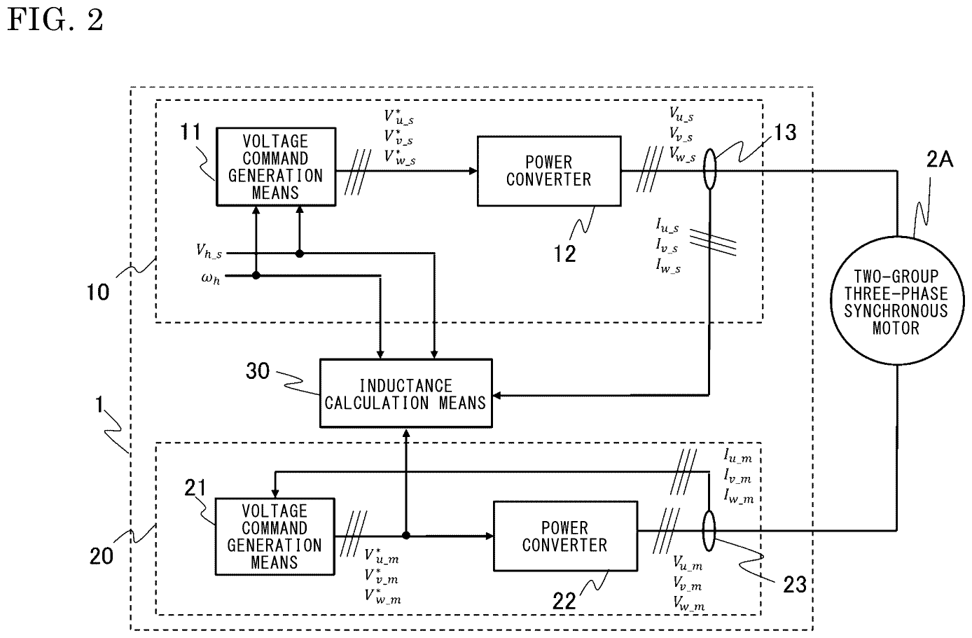

In embodiment 1, an example in which the multigroup multiphase AC machine 2 is a two-group three-phase synchronous motor is described. Therefore, the inductance measuring device 1 includes one self-measurement group and one interference measurement group. FIG. 2 is a block diagram showing a configuration of the inductance measuring device of the two-group three-phase synchronous motor according to embodiment 1. A first group of the two-group three-phase synchronous motor 2A is defined as the self-measurement group, and the self-measurement group voltage application means 10 is connected to the first group. A second group of the two-group three-phase synchronous motor 2A is defined as the interference measurement group, and the interference measurement group voltage application means 20 is connected to the second group.

In the following description, a value relevant to the self-measurement group is denoted with an index s, and a value relevant to the interference measurement group is denoted with an index m. In addition, a value relevant to the first group is denoted with an index 1, a value relevant to the second group is denoted with an index 2, a value relevant to interference occurring from the first group to the second group due to voltage application to the first group is denoted with an index 21, and a value relevant to interference occurring from the second group to the first group due to voltage application to the second group is denoted with an index _12.

Two axes of a fixed coordinate system are denoted as α axis and β axis, and two axes of a rotating coordinate system are denoted as d axis and q axis. The d axis is a reference direction in the rotating coordinate system, and for example, in a case of a synchronous motor having a field system, the d axis is set to be the field direction, and in a case of a synchronous motor not having a field system, such as a reluctance synchronous motor, the d axis is set to be the direction in which the inductance is maximum or minimum.

In FIG. 2, the self-measurement group voltage application means 10 includes voltage command generation means 11, a power converter 12, and a current detector 13. The interference measurement group voltage application means 20 includes voltage command generation means 21, a power converter 22, and a current detector 23.

### <Operation of Self-Measurement Group Voltage Application Means 10>

First, operation of the self-measurement group voltage application means 10 will be described.

The voltage command generation means 11 of the self-measurement group voltage application means 10 generates measurement voltage command values V*u_s, V*v_s, V*w_s which contribute to only inductance measurement without driving the two-group three-phase synchronous motor 2A. The voltage command generation means 11 outputs the measurement voltage command values V*u_s, V*v_s, V*w_s to the power converter 12. When the measurement voltage command values for three phases are collectively mentioned, they are referred to as measurement voltage command values V*uvw_s.

Here, in a case of using three-phase AC voltages with a voltage command angular frequency of ωh, a voltage command effective value Vh_s for each phase, and a phase difference of 120° between the phases, generation of the measurement voltage command values V*uvw_s will be described. In this case, measurement voltage command setting values inputted to the voltage command generation means 11 are the voltage command angular frequency ωh and the voltage command effective value Vh_s.

In order that the two-group three-phase synchronous motor 2A will not be driven, the voltage command angular frequency ωh is set to an angular frequency sufficiently higher than a rated electrical angular frequency that allows the two-group three-phase synchronous motor 2A to be driven, so that the measurement voltage commands V*uvw_s are set as high-frequency rotation voltages. It is desirable that the voltage command angular frequency ωh is higher than the rated electrical angular frequency as much as possible, and the voltage command angular frequency ωh may be ten times the rated electrical angular frequency, for example. The voltage command angular frequency ωh may be approximately three or four times the rated electrical angular frequency, as long as the two-group three-phase synchronous motor 2A is not driven owing to a relationship with another parameter such as an inertia.

The power converter 12 converts the measurement voltage commands V*u_s, V*v_s, V*w_s to measurement voltages Vu_s, Vv_s, Vw_s through PWM (pulse width modulation) with a triangular wave as a carrier, for example. That is, the power converter 12 serves as a voltage application unit for applying alternating voltages according to the measurement voltage commands V*u_s, V*v_s, V*w_s, to stator windings of the first group which is the self-measurement group of the two-group three-phase synchronous motor 2A. When the measurement voltages for three phases are collectively mentioned, they are referred to as measurement voltages Vuvw_s.

The current detector 13 detects three-phase current detection values Iu_s, Iv_s, Iw_s of the self-measurement group of the two-group three-phase synchronous motor 2A, and outputs the three-phase current detection values Iu_s, Iv_s, Iw_s to the inductance calculation means 30. When the current detection values for three phases are collectively mentioned, they are referred to as three-phase current detection values Iuvw_s.

### <Configuration and Operation of Interference Measurement Group Voltage Application Means 20>

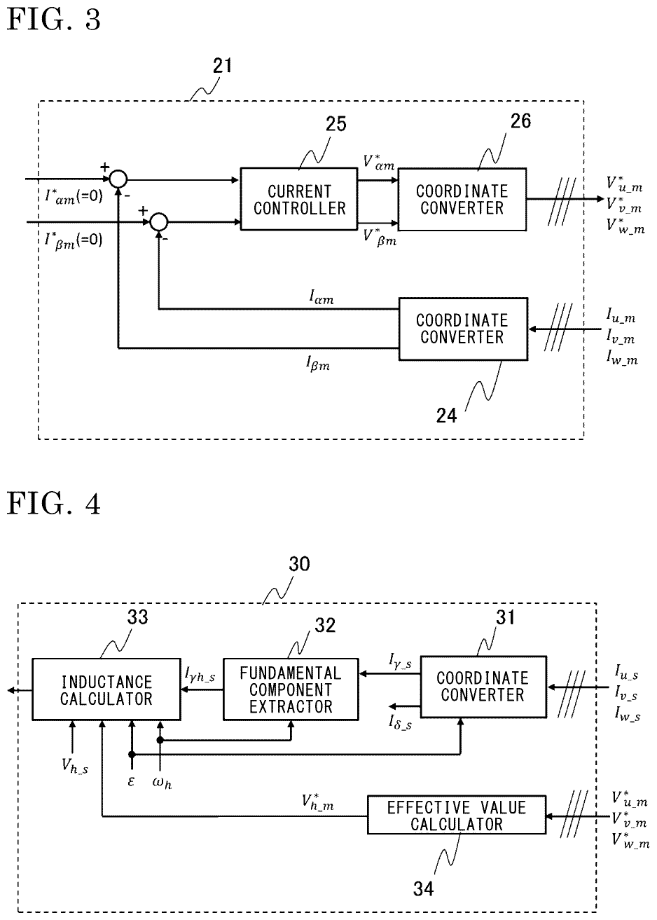

FIG. 3 is a block diagram showing a configuration of the voltage command generation means 21 in the interference measurement group voltage application means 20 according to embodiment 1. The voltage command generation means 21 includes a coordinate converter 24 which converts three axes to two axes, a current controller 25, and a coordinate converter 26 which converts two axes to three axes.

Next, operation of the interference measurement group voltage application means 20 will be described.

The current detector 23 detects three-phase current detection values Iu_m, Iv_m, Iw_m of the interference measurement group of the two-group three-phase synchronous motor 2A, and outputs the three-phase current detection values Iu_m, Iv_m, Iw_m to the coordinate converter 24 of the voltage command generation means 21. When the current detection values for three phases are collectively mentioned, they are referred to as three-phase current detection values Iuvw_m.

The coordinate converter 24 receives the three-phase current detection values Iuvw_m and converts the three-phase current detection values Iuvw_m to current detection values Iα_m and Iβ_m on α and β axes in a stationary coordinate system through coordinate conversion.

The α-axis current detection value Iα_m and the β-axis current detection value Iβ_m converted by the coordinate converter 24 are inputted via subtractors to the current controller 25. An α-axis current command value I*α_m is inputted to the positive side of the subtractor to which the α-axis current detection value Iα_m is inputted, and a β-axis current command value I*β_m is inputted to the positive side of the subtractor to which the β-axis current detection value Iβ_m is inputted. Here, the α-axis current command value I*α_m and the β-axis current command value I*β_m are 0.

The current controller 25 calculates voltage command values V*α_m and V*β_m so that the α-axis current detection value Iα_m coincides with the α-axis current command value I*α_m and the β-axis current detection value Iβ_m coincides with the β-axis current command value I*β_m. The current controller 25 outputs the α axis voltage command value V*α_m and the β axis voltage command value V*β_m to the coordinate converter 26.

Here, a current response angular frequency of the current controller 25 is set to be sufficiently higher than the voltage command angular frequency ωh used for calculation of the measurement voltage commands V*u_s, V*v_s, V*w_s in the self-measurement group. It is desirable that the current response angular frequency is set to be at least two to three times higher than the voltage command angular frequency ωh.

Along with voltage application according to the measurement voltage command values V*uvw_s for the self-measurement group, interference voltages having the voltage command angular frequency ωh due to change in an interfering magnetic flux from the self-measurement group occur in the interference measurement group. However, the current controller 25 performs control so that the current values on the α and β axes become 0, whereby voltage commands for causing the currents to be 0 against the interference voltages are outputted. At this time, by setting response of the current controller 25 to be sufficiently higher than the voltage command angular frequency ωh, it is possible to perform operation so as to sufficiently attenuate the components having the voltage command angular frequency ωh in the currents on the α and β axes. Therefore, regarding the voltage command values Vα_m* and Vβ_m* outputted from the current controller 25, components having the voltage command angular frequency ωh can be substituted with voltages for a case where currents are 0, i.e., voltages for an open-circuit state.

The α axis voltage command value V*α_m and the β axis voltage command value V*β_m inputted to the coordinate converter 26 are converted to three-phase voltage command values V*u_m, V*v_m, V*w_m through coordinate conversion from a two-axis stationary coordinate system, and the three-phase voltage command values V*u_m, V*v_m, V*w_m are outputted to the inductance calculation means 30 and the power converter 22. When the voltage command values for three phases are collectively mentioned, they are referred to as three-phase voltage command values V*uvw_m. The three-phase voltage command values V*uvw_m are interference measurement voltage command values.

As with the power converter 12, the power converter 22 converts the three-phase voltage command values V*uvw_m to voltages Vu_m, Vv_m, Vw_m through PWM with a triangular wave as a carrier, for example. That is, the power converter 22 serves as a voltage application unit for applying alternating voltages according to the three-phase voltage command values V*u_m, V*v_m, V*w_m, to the stator windings of the second group which is the interference measurement group of the two-group three-phase synchronous motor 2A. When the voltages for three phases are collectively mentioned, they are referred to as voltages Vuvw_m. The voltages Vuvw_m are interference measurement voltages.

### <Configuration and Operation of Inductance Calculation Means 30>

FIG. 4 is a block diagram showing a configuration of the inductance calculation means 30 according to embodiment 1. The inductance calculation means 30 includes a coordinate converter 31 which converts three axes to two axes, a fundamental component extractor 32, an inductance calculator 33, and an effective value calculator 34.

Next, operation of the inductance calculation means 30 will be described.

The inductance calculation means 30 receives the three-phase current detection values Iuvw_s of the self-measurement group, the three-phase voltage command values V*uvw_m of the interference measurement group, the voltage command angular frequency ωh, and the voltage command effective value Vh_s.

First, the coordinate converter 31 receives the three-phase current detection values Iuvw_s of the self-measurement group and a sweep phase angle ε. The coordinate converter 31 performs coordinate conversion from the three-phase current detection values Iuvw_s to currents on γ and δ axes which are coordinate axes with a sweep phase angle ε as a reference, obtained through rotation by the sweep phase angle ε, calculates a γ-axis current detection value Iγ_s(ε) corresponding to a reference direction, and outputs the γ-axis current detection value Iγ_s(ε).

The fundamental component extractor 32 receives the γ-axis current detection value Iγ_s(ε) and the voltage command angular frequency ωh. The fundamental component extractor 32 extracts a frequency component Iγh_s(ε) having the same frequency as the voltage command angular frequency ωh and included in the γ-axis current detection value Iγ_s(ε). For extraction of the fundamental component, arbitrary known means such as a band-pass filter may be used. The fundamental component extractor 32 outputs the γ-axis current high-frequency component Iγh_s(ε).

The effective value calculator 34 receives the three-phase voltage command values V*uvw_m of the interference measurement group. The effective value calculator 34 calculates a voltage command effective value V*h_m of the three-phase voltage command values V*uvw_m, and outputs the voltage command effective value V*h_m to the inductance calculator 33. In FIG. 4, the configuration in which the voltage command effective value is calculated from the three-phase voltage command values V*uvw_m is shown as an example. However, the voltage command effective value may be calculated from the α-axis and β-axis voltage command values V*α_m and V*β_m of the interference measurement group.

The inductance calculator 33 receives the γ-axis current high-frequency component Iγh_s(ε), the voltage command angular frequency ωh, the measurement voltage command effective value setting value Vh_s, and the voltage command effective value V*h_m. The inductance calculator 33 calculates a γ-axis inductance Lγ_s(ε) of the self-measurement group of the two-group three-phase synchronous motor 2A, using the following Formula (1).

$$\begin{matrix}[ Mathematical 1 ] & \\ {L}_{γ\_s} ( ε ) = \frac{{V}_{h\_s}}{{ω}_{h} \cdot {I}_{γh\_s} ( ε )} & ( 1 )\end{matrix}$$

Since the γ-axis current high-frequency component Iγh_s(ε) and the value V*h_m which is a substitute value for the interference voltage effective value at this time are inputted to the inductance calculator 33, a γ-axis interference inductance Mγ_m(ε) from the self-measurement group to the interference measurement group of the two-group three-phase synchronous motor 2A can be calculated from the above inputted values and the voltage command angular frequency ωh, using the following Formula (2).

$$\begin{matrix}[ Mathematical 2 ] & \\ {M}_{γ\_m} ( ε ) = \frac{{V}_{h\_m}^{*}}{{ω}_{h} \cdot {I}_{γh\_s} ( ε )} & ( 2 )\end{matrix}$$

The above processing is processing for one time in the sweep phase angle ε. The same processing is repeatedly performed while the sweep phase angle ε is changed from 0 [rad] to π [rad], whereby the γ-axis inductance Lγ_s(ε) (0≤ε≤π) of the self-measurement group and the γ-axis interference inductance Mγ_m(ε) (0≤ε≤π) from the self-measurement group to the interference measurement group with respect to the sweep phase angle ε are calculated in the inductance calculator 33.

Then, the minimum value and the maximum value of Lγ_s(ε) are calculated, one of the maximum value and the minimum value is determined as an inductance Ld_s on a reference d axis, and the other is defined as an inductance Lq_s on a reference q axis.

In addition, the minimum value and the maximum value of the γ-axis interference inductance Mγ_s(ε) are calculated, one of the maximum value and the minimum value is determined as an interference inductance Md_s on a reference d axis, and the other is defined as an interference inductance Mq_s on a reference q axis.

Here, since the number of groups is two, the first group is defined as the self-measurement group, and the second group is defined as the interference measurement group, the measured self-inductance is the self-inductance of the first group and the measured mutual inductance is the mutual inductance from the first group to the second group. Therefore, values are determined as Ld_s=Ld_1, Lq_s=Lq_1, Md_m=Md_21, and Mq_m=Mq_21.

### <Procedure in Inductance Measurement Operation>

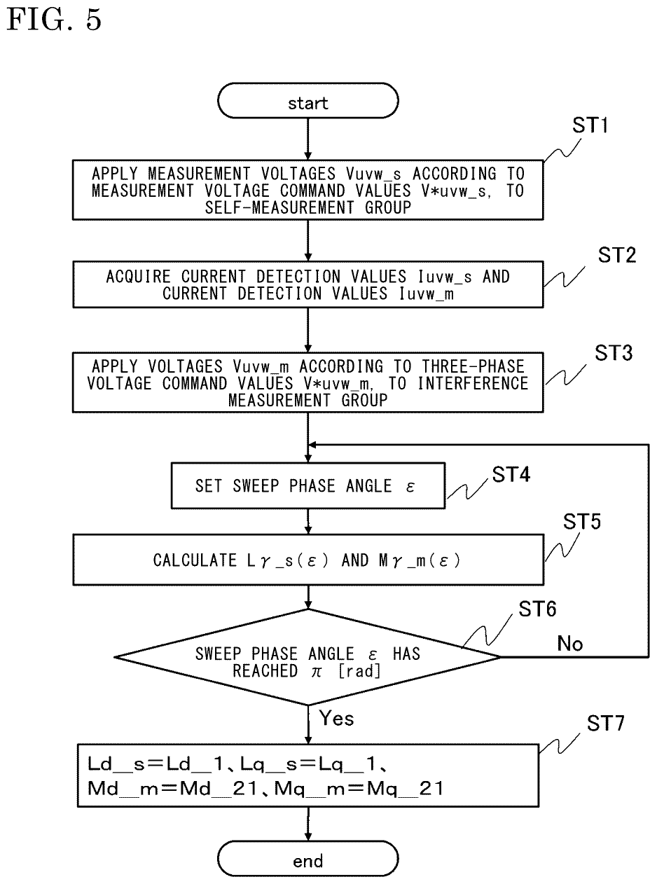

Next, with reference to a flowchart shown in FIG. 5, a procedure in inductance measurement operation using the inductance measuring device 1 according to embodiment 1 will be described.

First, in step ST1, the power converter 12 of the self-measurement group voltage application means 10 applies the measurement voltages Vuvw_s according to the measurement voltage command values V*uvw_s, to the self-measurement group which is the first winding group of the two-group three-phase synchronous motor 2A. The frequency of the voltages applied to the self-measurement group is sufficiently higher than the rated electrical angular frequency for driving the electric motor, and the electric motor is not driven even when the measurement voltages Vuvw_s are applied to the self-measurement group.

Next, in step ST2, the current detection values Iuvw_s are acquired from the current detector 13 of the self-measurement group voltage application means 10, and the current detection values Iuvw_m are acquired from the current detector 23 of the interference measurement group voltage application means 20.

Next, in step ST3, the power converter 22 of the interference measurement group voltage application means 20 applies the voltages Vuvw_m according to the three-phase voltage command values V*uvw_m, to the interference measurement group which is the second winding group of the two-group three-phase synchronous motor 2A.

Along with voltage application according to the measurement voltage command values V*uvw_s of the self-measurement group, interference voltages having the voltage command angular frequency ωh due to change in an interfering magnetic flux from the self-measurement group occur in the interference measurement group. The voltage command generation means 21 of the interference measurement group voltage application means 20 generates the three-phase voltage command values V*uvw_m on the basis of currents on xx and β axes obtained through coordinate conversion of the current detection values Iuvw_m, and voltage commands for causing the currents on α and β axes to be 0 against the above interference voltages are outputted. The current response angular frequency of the current controller 25 for generating the three-phase voltage command values V*uvw_m is set to be sufficiently higher than the voltage command angular frequency ωh used for calculation of the measurement voltage commands V*u_s, V*v_s, V*w_s in the self-measurement group, and therefore the electric motor is not driven even when the voltages V*uvw_m are applied to the interference measurement group which is the second winding group of the two-group three-phase synchronous motor 2A.

Next, in step ST4, the three-phase current detection values Iuvw_s of the self-measurement group, the three-phase voltage command values V*uvw_m of the interference measurement group, the voltage command angular frequency ωh, and the voltage command effective value Vh_s are inputted to the inductance calculation means 30, and the sweep phase angle ε for calculating the γ-axis inductance Lγ_s(ε) of the self-measurement group and the γ-axis interference inductance Mγ_m(ε) from the self-measurement group to the interference measurement group, is set.

Next, in step ST5, the γ-axis inductance Lγ_s(ε) of the self-measurement group and the γ-axis interference inductance Mγ_m(ε) from the self-measurement group to the interference measurement group with respect to the sweep phase angle ε are calculated.

Next, in step ST6, in order to perform calculation of the γ-axis inductance Lγ_s(ε) of the self-measurement group and the γ-axis interference inductance Mγ_m(ε) from the self-measurement group to the interference measurement group while changing the sweep phase angle ε from 0 [rad] to π [rad], whether or not the sweep phase angle ε has reached π [rad] is determined. Steps ST4 to ST6 are repeatedly executed until the sweep phase angle ε reaches π [rad].

In step ST6, if it is determined that calculation of the γ-axis inductance Lγ_s(ε) of the self-measurement group and the γ-axis interference inductance Mγ_m(ε) from the self-measurement group to the interference measurement group has been performed until the sweep phase angle ε has reached π [rad], the process proceeds to step ST7.

In step ST7, the inductance Ld_s on the d axis and the inductance Lq_s on the q axis are determined from the minimum value and the maximum value of the γ-axis inductance Lγ_s(ε) of the self-measurement group, and the interference inductance Md_s on the d axis and the interference inductance Mq_s on the q axis are determined from the minimum value and the maximum value of the γ-axis interference inductance Mγ_s(ε).

Here, since the number of the groups is two, the values are determined as Ld_s=Ld_1, Lq_s=Lq_1, Md_m=Md_21, and Mq_m=Mq_21.

Thus, both of the self-inductance of the self-measurement group and the interference inductance from the self-measurement group to the interference measurement group can be calculated.

Here, under the premise that the self-measurement group of the two-group three-phase synchronous motor 2A has saliency, the case of calculating the maximum and minimum inductances caused by the saliency has been described. However, in a case of not having saliency, Lγ_s(ε) does not have maximum and minimum peaks, resulting in Ld_s=Lq_s. Therefore, in a case where it is known in advance that the self-measurement group of the two-group three-phase synchronous motor 2A does not have saliency or the saliency is small enough to be negligible, processing may be performed for only one arbitrary value of the sweep phase angle ε [rad] without performing processing of changing the sweep phase angle ε from 0 [rad] to π [rad], thereby calculating the values as Lγ_s=Ld_s=Lq_s. Thus, the flow of repeatedly executing steps ST4 to ST6 may be omitted.

The same applies to the interference measurement group of the two-group three-phase synchronous motor 2A. In a case where it is known in advance that the interference measurement group of the two-group three-phase synchronous motor 2A does not have saliency or the saliency is small enough to be negligible, processing may be performed for only one arbitrary value of the sweep phase angle ε [rad] without performing processing of changing the sweep phase angle ε from 0 [rad] to π [rad], thereby calculating the values as Mγ_s=Md_m=Md_m. Thus, the flow of repeatedly executing steps ST4 to ST6 may be omitted.

Here, the example in which the first group is defined as the self-measurement group, the second group is defined as the interference measurement group, and the self-inductance of the first group and the interference inductance from the first group to the second group are measured, has been described. However, the second group may be defined as the self-measurement group, and the first group may be defined as the interference measurement group, whereby the self-inductances Ld_m=Ld_2 and Lq_m=Lq_2 of the second group and the interference inductances Md_s=Md_12 and Mq_s=Mq_12 from the second group to the first group may be calculated separately from the interference inductances from the first group to the second group.

Here, the example in which the number of the winding groups is two and the electric motor has two winding groups has been described. However, in a case where the electric motor has three or more groups of windings, as shown in FIG. 1, one of the groups may be defined as the self-measurement group and all the other groups may be defined as the interference measurement groups, whereby the self-inductance and the interference inductances from the self-measurement group to all the other interference measurement groups can be calculated. Then, each winding group is sequentially designated as the self-measurement group and operation is repeatedly performed, whereby the interference inductances from every winding group to the winding groups other than the self-measurement group can be individually calculated. That is, the flowchart shown in FIG. 5 may be performed as follows: one of the plurality of the winding groups is defined as the self-measurement group, the other winding groups are defined as the interference measurement groups, and the inductances are measured. Then, another winding group different from the winding group selected as the self-measurement group among the plurality of the winding groups is defined as an updated self-measurement group, the winding groups other than the updated self-measurement group are defined as updated interference measurement groups, and the inductances are measured. In this way, measurement is performed while sequentially performing update so that every one of the plurality of winding groups experiences the self-measurement group.

As described above, according to the present embodiment 1, the inductance measuring device which measures inductances of a multigroup multiphase AC machine includes: voltage application means which applies voltage and current detection means which detects current, the voltage application means and the current detection means being provided for each of a plurality of winding groups; and inductance calculation means which calculates the inductances. One of the plurality of winding groups is defined as a self-measurement group, and the winding group other than the self-measurement group is defined as an interference measurement group. The voltage application means for the self-measurement group applies, to the self-measurement group, measurement voltage which is voltage based on a measurement voltage command value and which does not drive the multigroup multiphase AC machine. The voltage application means for the interference measurement group includes a current controller, and applies, to the interference measurement group, interference measurement voltage which is voltage based on an interference measurement voltage command value for controlling current of the interference measurement group to be 0, and which does not drive the multigroup multiphase AC machine. The inductance calculation means calculates a self-inductance of the self-measurement group and a mutual inductance from the self-measurement group to the interference measurement group, on the basis of the current detected by the current detection means for the self-measurement group and the interference measurement voltage command value. With this configuration, the voltage command value which contributes to only inductance measurement without driving the multigroup multiphase AC machine is applied to the self-measurement group, to measure the self-inductance, and at the same time, current of the interference measurement group is controlled to be 0, whereby interference voltage occurring in the interference measurement group can be acquired and thus the interference inductance can be acquired. In addition, a configuration of a general AC machine control device that includes a power converter and does not have a voltage detector can be applied to the inductance measuring device that can measure the interference inductance.

In addition, since the voltage command angular frequency for generating the measurement voltage command value is set to be sufficiently higher than the angular frequency that allows the multigroup multiphase AC machine to be driven, inductance measurement can be performed in a state of not driving the multigroup multiphase AC machine.

In addition, since the response angular frequency of the current controller provided to the voltage application means for the interference measurement group is set to be sufficiently higher than the voltage command angular frequency, inductance measurement can be performed in a state of not driving the multigroup multiphase AC machine, and an angular frequency setting value component of the interference measurement voltage value can be controlled to be 0, whereby inductance calculation accuracy is improved.

Further, each winding group is sequentially designated as the self-measurement group and operation is repeatedly performed, whereby the interference inductance from one winding group to the other winding groups can be individually calculated for every winding group. Thus, even in a case where the interference inductances between one winding group and the other winding groups are different from each other, the respective interference inductances can be measured.

### Embodiment 2

Hereinafter, an inductance measuring device of a multigroup multiphase AC machine according to embodiment 2 will be described. In embodiment 2, unlike embodiment 1, the inductance measuring device 1 performs voltage application k times (k is a natural number not less than 2) while changing the voltage command effective value Vh_s so that the effective value current detection value Irms_s of the current detection values Iuvw_s of the self-measurement group differs at each time. Then, the same inductance calculation as in embodiment 1 is performed in each voltage application. In embodiment 2, the inductance measuring device 1 is configured correspondingly to the two-group three-phase synchronous motor 2A as in embodiment 1, and therefore the description thereof is omitted.

In the present embodiment 2, in step ST5 in FIG. 5, when the inductance calculator 33 of the inductance calculation means 30 calculates the γ-axis inductance Lγ_s(ε) of the self-measurement group and the γ-axis interference inductance Mγ_m(ε) from the self-measurement group to the interference measurement group with respect to the sweep phase angle ε, the inductance calculator 33 calculates also current Id_s on the d axis and current Iq_s on the q axis, on the basis of the γ-axis current high-frequency component Iγh_s(s) extracted by the fundamental component extractor 32.

For example, in a case where the maximum value of the γ-axis inductance Lγ_s(ε) of the self-measurement group is used for the d axis and is defined as the inductance Ld_s on the d axis, the current Id_s on the d axis becomes the minimum value of the γ-axis current high-frequency component Iγh_s(ε). In a case where the minimum value of the γ-axis inductance Lγ_s(ε) of the self-measurement group is used for the d axis and is defined as the inductance Ld_s on the d axis, the current Id_s on the d axis becomes the maximum value of the γ-axis current high-frequency component Iγh_s(ε).

Then, the current Iq_s on the q axis becomes the other value in each of the above cases. That is, when the current Id_s on the d axis is the minimum value of the γ-axis current high-frequency component Iγh_s(s), the current Iq_s on the q axis becomes the maximum value of the γ-axis current high-frequency component Iγh_s(ε), and when the current Id_s on the d axis is the maximum value of the γ-axis current high-frequency component Iγh_s(ε), the current Iq_s on the q axis becomes the minimum value of the γ-axis current high-frequency component Iγh_s(ε).

In this way, while voltage application is performed a plurality of (k) times, the current Id_s(k) on the d axis and the current Iq_s(k) on the q axis, and the inductance Ld_s(k) on the d axis and the inductance Lq_s(k) on the q axis of the self-measurement group and the interference inductance Md_s(k) on the d axis and the interference inductance Mq_s(k) on the q axis from the self-measurement group to the interference measurement group, corresponding the above currents, can be calculated.

A plurality of measurement points of the current Id_s(k) on the d axis and the inductance Ld_s(k) on the d axis, the current Iq_s(k) on the q axis and the inductance Lq_s(k) on the q axis, the current Id_s(k) on the d axis and the interference inductance Md_s(k) on the d axis, and the current Iq_s(k) on the q axis and the interference inductance Mq_s(k) on the q axis may be subjected to a method for deriving a function relationship, e.g., a least squares method, whereby a change characteristic in which each inductance value changes due to magnetic saturation along with change in the current values can be calculated.

As in embodiment 1, in a case where it is known in advance that the winding groups of the self-measurement group and the interference measurement group do not have saliency or the saliency is small enough to be negligible, processing may be performed for only one arbitrary value of the sweep phase angle ε [rad] without performing processing of changing the sweep phase angle ε from 0 [rad] to π [rad], thereby only calculating the values as L_s(k)=Ld_s(k)=Lq_s(k), I_s(k)=Id_s(k)=Iq_s(k), and M_s(k)=Md_s(k)=Mq_s(k). Thus, the flow of repeatedly executing steps ST4 to ST6 in FIG. 5 may be omitted.

As described above, according to embodiment 2, the same effects as in embodiment 1 are provided. Further, voltage application is performed k (≥2) times while changing the voltage command effective value Vh_s, and the current Id_s(k) on the d axis and the current Iq_s (n) on the q axis due to a plurality of times of voltage application, and the inductance Ld_s(k) on the d axis and the inductance Lq_s(k) on the q axis of the self-measurement group and the interference inductance Md_s(k) on the d axis and the interference inductance Mq_s(k) on the q axis which are interference inductances from the self-measurement group to the interference measurement group, corresponding to the above currents, are calculated. Thus, a change characteristic in which each inductance value changes due to magnetic saturation along with change in the current values can be calculated.

### Embodiment 3

In embodiment 3, a measurement target of the inductance measuring device for the multigroup multiphase AC machine described in each of embodiments 1 and 2 will be described below with reference to the drawings.

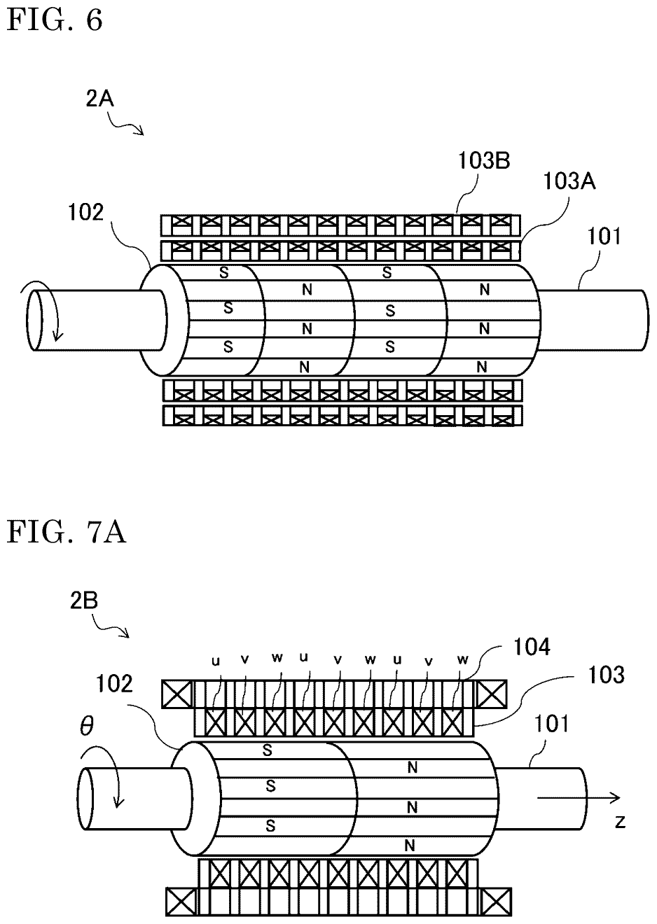

FIG. 6 schematically shows a configuration of a two-group three-phase synchronous motor as an example of the multigroup multiphase AC machine 2. In FIG. 6, the two-group three-phase synchronous motor 2A includes permanent magnets 102 around a movable element 101, and two stator winding groups 103A and 103B are formed in two layers while being separated in the radial direction from the permanent magnets 102. The stator winding groups 103A and 103B are respectively supplied with power from independent power converters, whereby the two-group three-phase synchronous motor 2A is driven. In FIG. 6, the stator winding groups 103A and 103B are shown as cross-sections.

In a case of measuring the inductance of the two-group three-phase synchronous motor 2A, for example, the stator winding group 103A is defined as the first group which is the self-measurement group and the stator winding group 103B is defined as the second group which is the interference measurement group so that voltage is applied to the stator winding group 103A from the self-measurement group voltage application means 10 and voltage is applied to the stator winding group 103B from the interference measurement group voltage application means 20. Thus, the inductance measuring device 1 can acquire the self-inductance and the mutual inductance with high accuracy without rotating the two-group three-phase synchronous motor 2A.

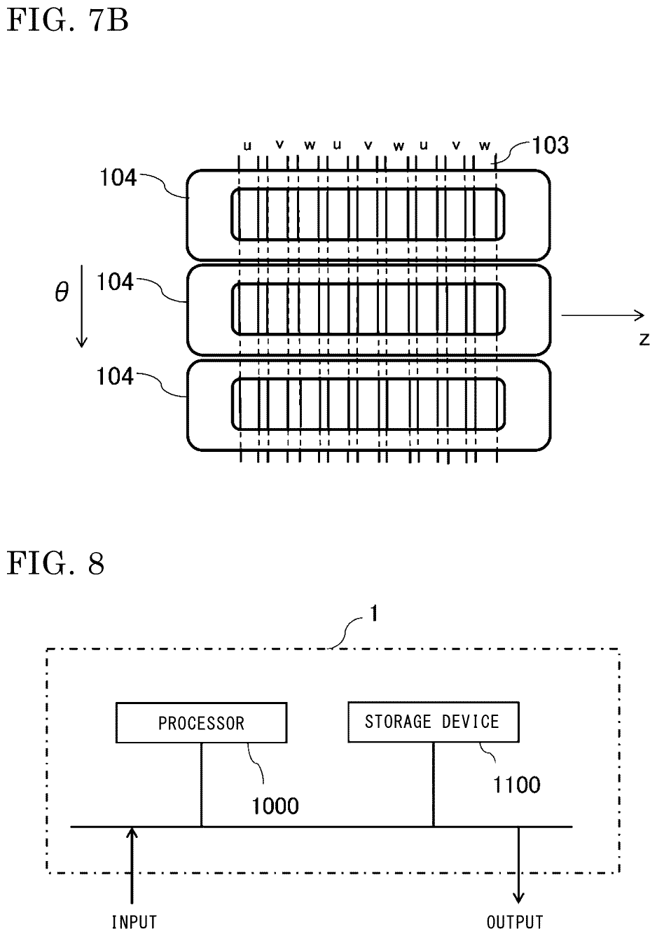

FIG. 7A and FIG. 7B schematically show a configuration of a linear and rotary actuator 2B which is one of actuators with multiple degrees of freedom, as an example of the multigroup multiphase AC machine 2. In FIG. 7A, the linear and rotary actuator includes the permanent magnets 102 around the movable element 101, and two stator winding groups 103 and 104 are formed in two layers while being separated in the radial direction from the permanent magnet 102. The stator winding groups 103 and 104 are respectively supplied with power from independent power converters, whereby the linear and rotary actuator 2B is driven. In FIG. 7A, the stator winding groups 103 and 104 are shown as cross-sections.

The stator winding group 103 is a z-axis stator winding group for generating an advancement magnetic field in a linear z direction of the movable element 101. On the other hand, the stator winding group 104 is a θ-axis stator winding group for generating a rotational magnetic field in a rotation θ direction of the movable element 101. FIG. 7B is an enlarged view of the stator winding groups 103 and 104 as seen from a lateral side. The stator winding group 103 has a plurality of windings for phases arranged in the z-axis direction, and the stator winding group 104 has a plurality of windings arranged in the θ direction, as shown in FIG. 7B.

By applying the inductance measuring device 1 according to embodiment 1 or 2 described above, it becomes possible to acquire the self-inductance and the mutual inductance with high accuracy without operating the linear and rotary actuator 2B. Also in this case, for example, the stator winding group 103 is defined as the first group which is the self-measurement group and the stator winding group 104 is defined as the second group which is the interference measurement group so that voltage is applied to the stator winding group 103 from the self-measurement group voltage application means 10 and voltage is applied to the stator winding group 104 from the interference measurement group voltage application means 20, or the setting opposite to the above is made, thereby acquiring the self-inductance and the mutual inductance.

Thus, the inductance measuring device 1 according to embodiment 1 or 2 described above makes it possible to acquire the self-inductance and the mutual inductance with high accuracy without operating an actuator having multiple degrees of freedom.

In FIG. 6, the two-group three-phase synchronous motor 2A is shown as an example. However, more winding groups may be formed in the circumferential direction, whereby the inductance measuring device 1 can be applied to a multigroup multiphase AC machine having more than two winding groups.

As described above, embodiment 3 provides the same effects as in embodiments 1 and 2.

FIG. 8 shows an example of a hardware configuration of the inductance measuring device 1 according to each of the above embodiments 1 to 3. As shown in FIG. 8, the inductance measuring device 1 includes a processor 1000 and a storage device 1100 as a processing circuit, for example.

The processor 1000 may include a CPU (central processing unit), an ASIC (application specific integrated circuit), an IC, an FPGA (field programmable gate array), various logic circuits, various signal processing circuits, and the like. The processor 1000 may include a plurality of processors of the same type or different types, and each process may be executed in a shared manner. The storage device 1100 includes a RAM (random access memory) configured to allow data to be read and written from the processor 1000, a ROM (read only memory) configured to allow data to be read from the processor 1000, and the like. The processor 1000 executes a program inputted from the storage device 1100 such as the ROM.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 inductance measuring device
2 multigroup multiphase AC machine
2A two-group three-phase synchronous motor
2B linear and rotary actuator
10 self-measurement group voltage application means
11 voltage command generation means
12 power converter
13 current detector
20 interference measurement group voltage application means
21 voltage command generation means
22 power converter
23 current detector
24 coordinate converter
25 current controller
26 coordinate converter
30 inductance calculation means
31 coordinate converter
32 fundamental component extractor
33 inductance calculator
34 effective value calculator
101 movable element
102 permanent magnet
103, 103A, 103B, 104 stator winding group
1000 processor
1100 storage device

1. An inductance measuring device which measures inductances of a multigroup multiphase AC machine having a plurality of multiphase winding groups, the inductance measuring device comprising:
voltage application circuitry to apply voltage and current detector to detect current, the voltage application circuitry and the current detector being provided for each of the plurality of winding groups; and
inductance calculation circuitry to calculate the inductances, wherein
one of the plurality of winding groups is defined as a self-measurement group, and the winding group other than the self-measurement group is defined as an interference measurement group,
the voltage application circuitry for the self-measurement group applies, to the self-measurement group, measurement voltage which is voltage based on a measurement voltage command value and which does not drive the multigroup multiphase AC machine,
the voltage application circuitry for the interference measurement group includes a current controller, and applies, to the interference measurement group, interference measurement voltage which is voltage based on an interference measurement voltage command value for controlling current of the interference measurement group to be 0, and which does not drive the multigroup multiphase AC machine, and
the inductance calculation circuitry calculates a self-inductance of the self-measurement group and a mutual inductance from the self-measurement group to the interference measurement group, on the basis of the current detected by the current detector for the self-measurement group and the interference measurement voltage command value.

2. The inductance measuring device according to claim 1, wherein
the measurement voltage is multiphase AC voltages, and a voltage command angular frequency for generating the measurement voltage command value is set to be higher than an angular frequency that allows the multigroup multiphase AC machine to be driven.

3. The inductance measuring device according to claim 2, wherein
a response angular frequency of the current controller is set to be higher than the voltage command angular frequency.

4. The inductance measuring device according to claim 1, wherein
another one different from the self-measurement group among the plurality of winding groups is defined as an updated self-measurement group, and the winding group other than the updated self-measurement group is defined as an updated interference measurement group, and
for the updated self-measurement group and the updated interference measurement group, the inductance calculation circuitry calculates the self-inductance of the updated self-measurement group and the mutual inductance from the updated self-measurement group to the updated interference measurement group.

5. The inductance measuring device according to claim 1, wherein
the voltage application circuitry for the self-measurement group changes a voltage command effective value so that an effective value of a current value detected by the current detector provided to the voltage application means for the self-measurement group differs, to generate the measurement voltage command value that is different, and applies the measurement voltage that is different, to the self-measurement group, on the basis of the different measurement voltage command value, and
for each of the effective values of the different current values, the inductance calculation circuitry calculates the self-inductance of the self-measurement group and the mutual inductance from the self-measurement group to the interference measurement group.

6. The inductance measuring device according to claim 1, wherein
the inductance calculation circuitry includes
a fundamental component extractor which extracts fundamental component current which is the same frequency component as a voltage command angular frequency for generating the measurement voltage command value, from the current detected by the current detector for the self-measurement group, and
an effective value calculator which calculates an effective value of the interference measurement voltage command value, and
the inductance calculation circuitry calculates the self-inductance of the self-measurement group and the mutual inductance from the self-measurement group to the interference measurement group, on the basis of the fundamental component current, the effective value of the interference measurement voltage command value, the voltage command angular frequency, and a voltage command effective value for generating the measurement voltage command value.

7. The inductance measuring device according to claim 1, wherein
the multigroup multiphase AC machine as a target for which the inductances are to be measured is a two-group three-phase synchronous motor.

8. The inductance measuring device according to claim 1, wherein
the multigroup multiphase AC machine as a target for which the inductances are to be measured is a linear and rotary actuator in which magnetic fields based on two said winding groups are generated orthogonally to each other.

9. An inductance measuring method for measuring inductances of a multigroup multiphase AC machine having a plurality of multiphase winding groups, the inductance measuring method comprising:
defining one of the plurality of winding groups as a self-measurement group, and defining the winding group other than the self-measurement group as an interference measurement group;
applying, to the self-measurement group, measurement voltage which is voltage based on a measurement voltage command value and which does not drive the multigroup multiphase AC machine;
detecting current of the self-measurement group and current of the interference measurement group;
applying, to the interference measurement group, interference measurement voltage which is voltage based on an interference measurement voltage command value for controlling current of the interference measurement group to be 0, and which does not drive the multigroup multiphase AC machine; and
calculating a self-inductance of the self-measurement group and a mutual inductance from the self-measurement group to the interference measurement group, on the basis of the current detected by the current detector for the self-measurement group and the interference measurement voltage command value.

10. The inductance measuring method according to claim 9, comprising:
defining another one different from the self-measurement group among the plurality of winding groups as an updated self-measurement group, and defining the winding group other than the updated self-measurement group as an updated interference measurement group;
for the updated self-measurement group and the updated interference measurement group, calculating the self-inductance of the updated self-measurement group and the mutual inductance from the updated self-measurement group to the updated interference measurement group; and
sequentially measuring the inductances of the multigroup multiphase AC machine so that every winding group of the plurality of winding groups experiences the self-measurement group.

11. The inductance measuring method according to claim 9, comprising:
changing a voltage command effective value so that an effective value of a current value of the self-measurement group differs, to generate the measurement voltage command value that is different, and sequentially applying the measurement voltage that is different, to the self-measurement group, on the basis of the different measurement voltage command value; and
for each of the effective values of the different current values, calculating the self-inductance of the self-measurement group and the mutual inductance from the self-measurement group to the interference measurement group.
